(19) United States
(12) Patent Application Publication
(10) Pub. No.: US 2002/0085469 A1
(43) Pub. Date: Jul. 4, 2002

(54) Optimization of data recovery level for most error-free reading of optical disks

(75) Inventor: Minoru Minase, Iruma-shi (JP)

Correspondence Address: Michael P. Dunnam, Esq., WOODCOCK WASHBURN LLP, One Liberty Place, 46th Floor, Philadelphia, PA, 19103, US

(73) Assignee: TEAC Corporation

(21) Appl. No.: 10/059,958

(22) Filed: Nov. 16, 2001

(30) Foreign Application Priority Data
Dec. 1, 2000 (JP) 2000-367524

(51) Int. Cl. G11B 7/005

(52) U.S. Cl. 369/53.35; 369/53.37

(57) ABSTRACT

An optical disk drive capable of error-free reading of any such optical disks as CDs, CD-Rs and CD-RWs in the face of a possible offset in the asymmetry of the RF data signal from the transducer. Included is a comparator for providing a binary data signal comparing the RF data signal with a reference voltage fed back from the comparator output via a low-pass filter. For optimization of the reference voltage for most error-free reading, an optimization circuit is provided which supplies a series of corrective values to be added to the reference voltage. Having an input connected to an error detector/corrector circuit on the output side of the comparator, the optimization circuit compares the error rates at all the corrective values added to the reference voltage and determines the optimum corrective value at which the error rate is at a minimum.

### BACKGROUND OF THE INVENTION

This invention relates to an apparatus for reading an optical disk, and more particularly to a method of, and means for, reduction of the read error rate to a minimum in such an apparatus. The invention is particularly well applicable to optical disk drives that are to be put to use with any of such interchangeable optical disks as CD-ROMs, CD-Rs, and CD-R/RWs.

With the ever-growing commercial acceptance of optical disks as compact, inexpensive data storage media, optical disk drives have become an almost indispensable peripheral of personal computers. U.S. Pat. No. 5,844,872 to Kubo et al. is hereby cited as dealing with an optical disk drive comparable in construction to that of the instant invention. This and many other known types of optical disk drives are alike in having a wave-shaping circuit in the form of a comparator to which is input a radio-frequency data signal supplied from an optoelectric transducer reading the disk. Supplied to the other input of the comparator is a constant-magnitude reference signal which, ideally, has the mean value of the radio-frequency data signal. The resulting output from the comparator is a binary signal consisting of a series of rectangular pulses of varying durations.

The usual practice for production of the constant-magnitude reference signal is to feed the comparator output back into its own input via a low-pass filter, such that the reference signal has a voltage approximately equal to the mean value of the amplitude of the radio-frequency data signal.

A problem, potentially involving read errors, has recently occurred in the art, due in part to today's higher speeds of data recovery from optical disks, and in part to the greater variety of optical disks, CDs, CD-ROMs, CD-Rs, and CD-RWs, that must be handled by one disk drive. The reference signal level often deviated from the mean value of the data signal amplitude, resulting in undesired variations in the durations of the comparator output pulses. These variations could lead to the malfunctioning of the phase-locked loop circuit connected to the comparator output for clocking, and, in the worst case, to read errors. How such read errors occur will be later discussed in some more detail with reference to the drawings attached hereto.

### SUMMARY OF THE INVENTION

The present invention has it as an object to reduce read errors of optical disks to a minimum through optimization of the reference signal level applied to the wave-shaping comparator.

Another object of the invention is to make it possible for an apparatus of the kind under consideration to handle any of the various known types of interchangeable optical disks equally well with a minimum of read errors.

Still another object of the invention is to automate the process of reference signal level optimization, preprogramming the apparatus to automatically carry out the process each time it is switched on or each time a disk is reloaded.

Briefly stated in one aspect thereof, the present invention may be summarized as an apparatus for reading of an optical disk. Included is a comparator having a first input connected to an optoelectric transducer for receiving therefrom an electric signal indicative of data recovered from an optical disk, and a second input connected to its own output via reference signal means. Comparing the transducer output with a reference voltage supplied by the reference signal means, the comparator translates the transducer output into a binary signal. A demodulator circuit is connected to the comparator for demodulating the binary comparator output into a data signal, which is subsequently directed into an error detector/corrector circuit for error correction. The error detector/corrector circuit includes error rate detector means. Connected between the error detector/corrector circuit and the reference signal means is a corrective circuit which supplies to the latter a signal indicative of a corrective value to be added to the reference signal according to the error rate of the data signal, in order to optimize the reference signal for a minimum error rate of the data signal.

Another aspect of the invention concerns a method of most error-free reading of an optical disk, to be implemented with the apparatus summarized above. For optimization of the reference voltage being applied to the comparator, the method dictates successive addition of a series of incremental corrective values to the reference voltage. The optimum corrective value, a value at which the error rate of the data signal is at a minimum, is ascertained by detecting the error rate of the data signal at each of the corrective values added to the reference voltage and comparing these error rates. The optimum corrective value is then added to the reference voltage for most error-free reading of the disk.

Thus the invention relies on the actual error rate of the data signal resulting from the addition of each of a series of prescribed corrective values to the comparator reference voltage. The optimum corrective value is then determined on the basis of the minimum error rate resulting therefrom. The comparator reference voltage is therefore most reasonably corrected and optimized for most error-free reading.

The optimization of the comparator reference voltage is to be effected for each of the optical disks, including CDs, CD-Rs, and CD-RWs, to be interchangeably loaded in the apparatus. Once optimized, however, the comparator reference voltage can be held unvaried until the disk is unloaded, or the apparatus turned off, so that a minimal length of time is needed for the optimization.

As will also be disclosed herein, the optimization process can be preprogrammed into the apparatus. The optimization subroutine is invoked each time a disk is loaded in the apparatus, or the apparatus turned on with a disk loaded. Each disk on being loaded into the apparatus is therefore to be read with the comparator voltage automatically optimized for that particular disk.

The above and other objects, features and advantages of this invention will become more apparent, and the invention itself will best be understood, from a study of the following description and appended claims, with reference had to the attached drawings showing the preferred embodiments of the invention.

### BRIEF DESCRIPTION OF THE DRAWINGS

FIG. 1 is a block diagram of a preferred form of optical disk reading apparatus incorporating the features of the invention, the apparatus being shown as an optical disk drive interfaced with a personal computer for use as a peripheral thereof;

FIG. 2 is a schematic electrical diagram of the feedback circuit of the comparator used in the FIG. 1 apparatus for translating the RF transducer output into a binary signal;

FIG. 3 is a block diagram equivalently depicting the optimization circuit connected to the FIG. 2 comparator feedback circuit for optimization of the comparator reference voltage;

FIG. 4 is a graph plotting the relationships between the corrective values applied from the FIG. 3 optimization circuit to the FIG. 2 comparator feedback circuit and the error rates of the resulting data signal, as exhibited by three different optical disks to be interchangeably loaded in the FIG. 1 apparatus;

FIG. 5, consisting of (A) and (B), is a diagram showing the waveforms of a normal data signal input to the comparator of the FIG. 1 apparatus and the resulting binary output therefrom;

FIG. 6, consisting of (A) through (C), is a diagram showing the waveforms of an abnormal data signal input to the comparator of the FIG. 1 apparatus, the resulting comparator output when the comparator reference voltage is not optimized according to the prior art, and the comparator output when the comparator reference voltage is optimized according to the invention; and

FIGS. 7A and 7B in combination is a flowchart of how the comparator reference voltage is optimized for each optical disk loaded into the FIG. 1 apparatus.

### DESCRIPTION OF THE PREFERRED EMBODIMENT

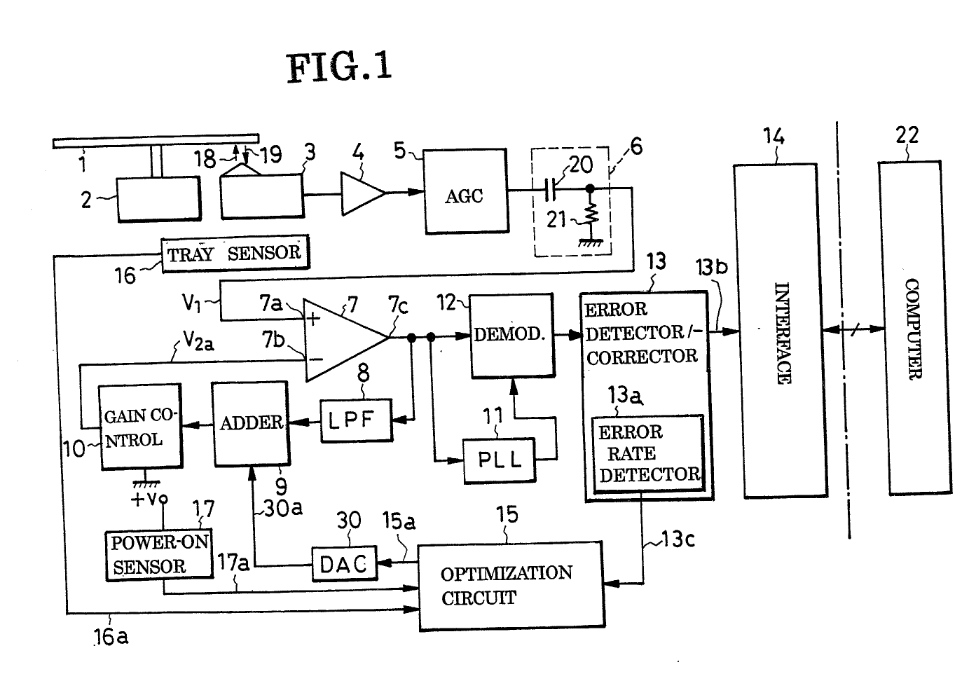

The present invention will now be described as embodied in the illustrated optical disk drive interfaced with a personal computer for use as a peripheral thereof, for data recovery from any of a variety of interchangeable optical disks of the standard CD format. Such an optical disk is shown replaceably mounted at 1 on a turntable in the apparatus of FIG. 1 in order to be driven directly by an electric disk drive motor 2. It is understood that the disk 1 has data prerecorded thereon in the form of a multiturn spiral of minute bumps or pits impressed into its recording layer, such data being to be read at a constant linear velocity. The data of the disk 1 include main data and error correcting data according to the known Cross Interleave Reed-Solomon Code or CIRC as the error correcting code. Held opposite the data-bearing surface of the disk 1, an optical pickup or transducer 3 travels across the turns of the data track thereon for reading the data through the medium of a beam of light produced by a source such as a laser built into the transducer. In FIG. 1 the beam impinging on the disk surface is designated 18, and the reflection therefrom 19.

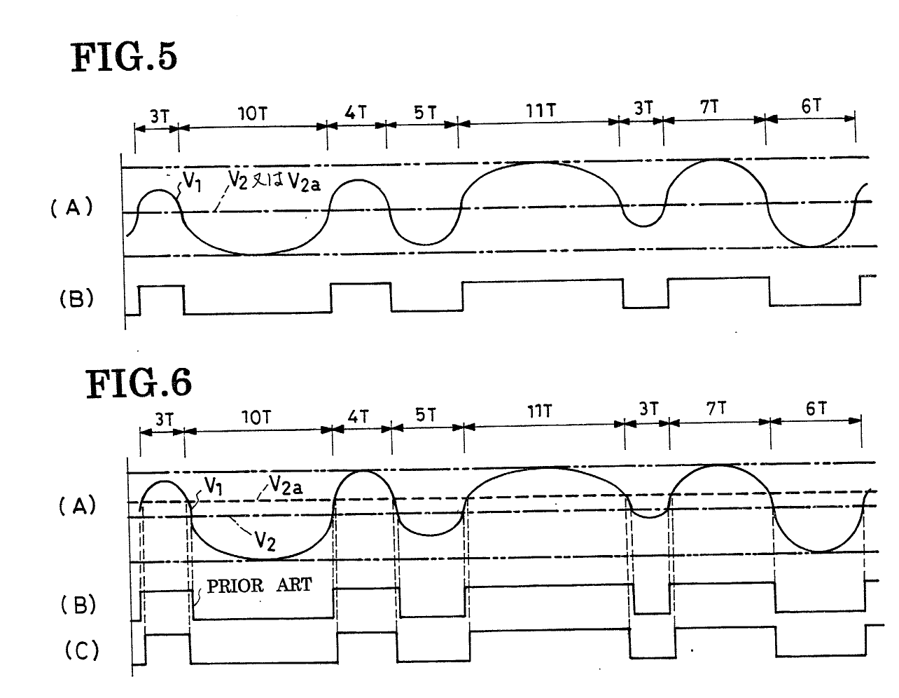

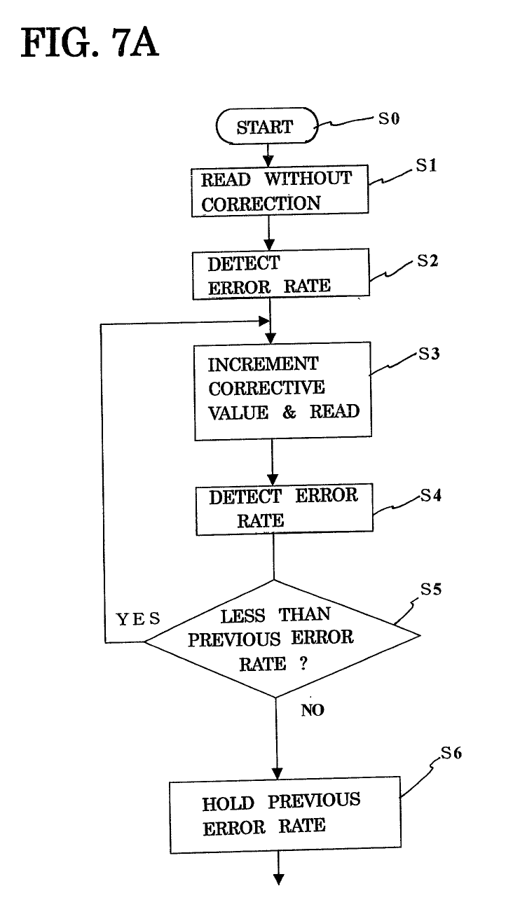

The transducer 1 is electrically connected to a radio-frequency amplifier 4 thereby to have its radio-frequency output, representative of the data recovered from the disk 1, amplified with a waveform equivalence function. The output from the amplifier 4 is directed into an automatic gain control circuit 5, which functions to keep its output substantially constant in strength despite possible changes in input signal strength. Connected to the gain control circuit 5, an alternating-current coupling circuit 6 is of the familiar design comprising a coupling capacitor 20 and a resistor 21 for deriving the a.c. component only from the gain control circuit output. The output from the a.c. coupling circuit 6 will be hereinafter referred to as the data signal, which is shown at (A) in both FIGS. 5 and 6 and therein designated V₁.

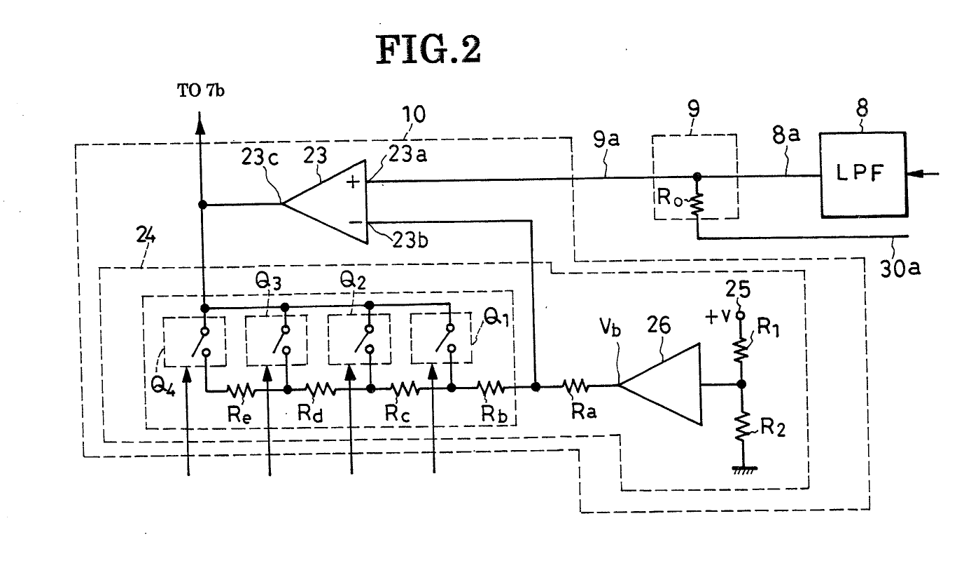

A comparator 7 has one input 7a connected to the a.c. coupling circuit 6, and another input 7b to its own output 7c, in order to serve as a wave-shaping circuit for translating the data signal V₁ into the binary signal indicated at (B) in FIG. 5 and (C) in FIG. 6. Inserted between comparator output 7c and input 7b is a serial feedback circuit of a low-pass filter 8, an adder circuit 9, and a gain control circuit 10, which in combination are designed to provide a reference signal V₂ₐ in the form of a unidirectional voltage against which the data signal V₁ is to be compared. The reference signal V₂ₐ is approximately equal to the mean value of the amplitude of the data signal V₁; for example, approximately 2.5 volts if the maximum voltage of the data signal is 5.0 volts, and the minimum zero. This reference signal is not a simple feedback of the output of the comparator output but is optimized for each disk being played, with a view to reduction of the read error rate to a minimum according to the novel concepts of the invention. More will be said presently about the LPF 8, adder circuit 9 and gain control circuit 10 with reference to FIG. 2, as they are closely associated with the features of the invention, and about how the reference signal is optimized.

The comparator 7 has its output connected to both a phase-locked loop circuit 11 and an EFM demodulator circuit 12. The PLL circuit 11 generates a bit clock signal in synchronism with the binary EFM signal, for delivery to the demodulator circuit 12. This demodulator circuit turns the EFM signal into read data containing the bits of primary data in addition to parity bits for error detection and correction. The read data is put out from the demodulator circuit 12 in synchronism with the bit clock pulses of the PLL circuit 11.

Connected to the output of the demodulator circuit 12 is an error detector/corrector circuit 13 which conventionally detects and corrects errors in the read data or the main data by the known cross interleave Reed-Solomon codes generally adopted for error correction in CDs. The error detector/corrector circuit 13 has an output connected to an interface circuit 14 for sending the corrected read data thereto by way of a line 13b. The error detector/corrector circuit 13 includes an error rate detector 13a. The error rate detector 13a detects error rates of the read data. The error rate is a rate of fne number of the read data which have errors toward the number of the read data. The error rate detector 13a has an output connected to a reference level optimization circuit 15 (hereinafter referred to simply as the optimization circuit) by way of a line 13c. The interface circuit 14 forwards the corrected read data on to a personal computer 22.

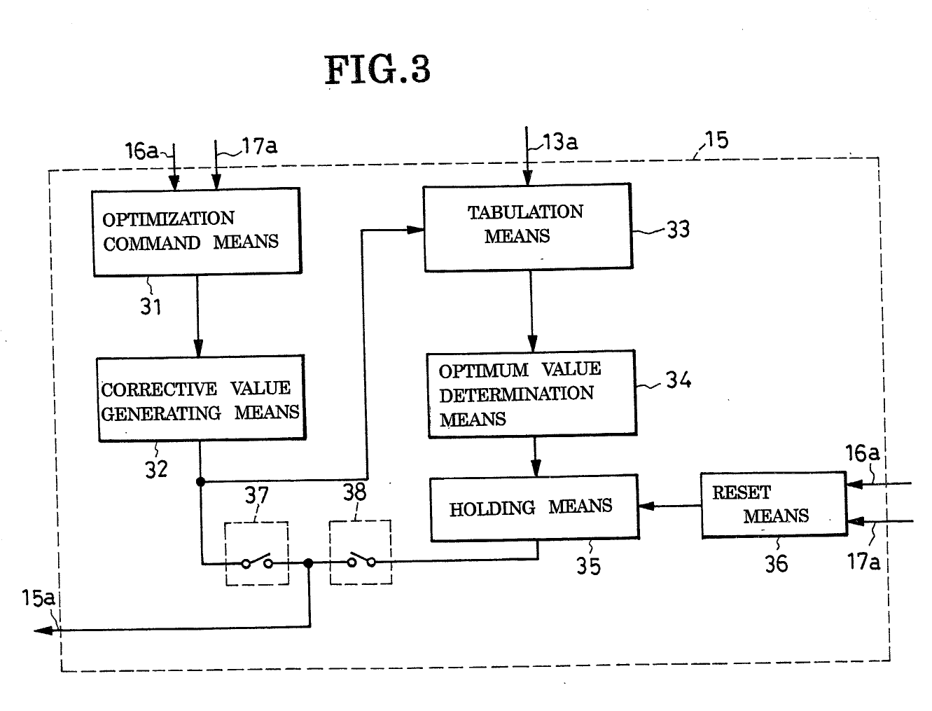

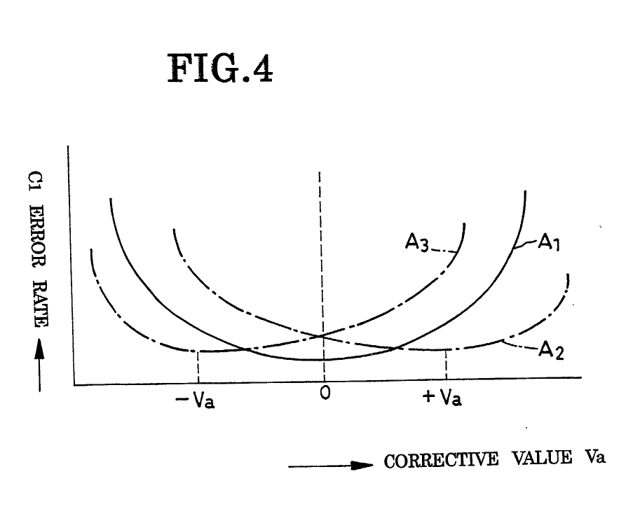

Constituting a most pronounced feature of the invention, the optimization circuit 15 as corrective circuit determines an optimum corrective value, from among a series of prescribed corrective values, for the comparator reference voltage signal V₂ₐ, a value to be added to, specifically, the output from the LPF 8 for optimization of the comparator reference voltage. The optimum corrective value is chosen on the basis of the error rates of the read data being recovered from each particular disk 1 upon addition of the various possible corrective values to the comparator reference voltage. The error rates are supplied from the error rate detector 13a. The corrective values are sent to the adder circuit 9 via a digital-to-analog converter 30. Reference will be later had to FIG. 3 for more detailed consideration of the construction of the optimization circuit 15, and to FIG. 4, too, for that of its operation.

At 16 in FIG. 1 is shown a tray sensor 16 comprising a Microswitch or the like for sensing a disk tray, not shown, a standard component of the disk drive, as the tray is positioned to hold the disk 1 in position to be read by the transducer 3. The tray sensor 16 is connected to the optimization circuit 15 by way of a line 16a. A power-on sensor 17 is also connected to the optimization circuit 15 by way of a line 17a for informing the latter of whether the disk drive is electrically powered on or not. The signals thus supplied from sensors 16 and 17 to optimization circuit 15 are utilized for invoking the reference level optimization program introduced into the optimization circuit, as will be better understood as the description progresses.

Reference may be had to FIG. 2 for the following more detailed discussion of the LPF 8, adder circuit 9, and gain control circuit 10 constituting the feedback circuit of the comparator 7. The LPF 8 is to be preset to provide a unidirectional voltage approximately equal to the mean value of the output amplitude of the comparator 7. The output voltage of the LPF 8 is amended and optimized in the adder circuit 9 by the analog equivalent of the digital corrective value supplied from the optimization circuit 15 via the DAC 30, preliminary to application via the gain control circuit 10 to the input 7b of the comparator 7 as the reference voltage.

The adder circuit 9 is formed by connecting the output line 30a of the DAC 30 to the output line 8a of the LPF 8 via a resistor R₀. Therefore, as indicated at (A) in FIG. 6, the comparator reference voltage can be shifted as from V₂ to V₂ₐ upon application of the corrective voltage from DAC 30 to adder circuit 90 over the line 30a. The result is the production, by the comparator 7, of the FIG. 6 (C) output which is practically equivalent to that of FIG. 5 (B) in the face of the offset asymmetry of the data signal V₁ from FIG. 5 (A) to FIG. 6 (A).

The problem previously pointed out in connection with the prior art will become more apparent from a study of FIGS. 5 and 6. FIG. 5 indicates at (A) the waveform of the normal eight-to-fourteen modulated data signal V₁ and at (B) that of the corresponding binary output from the comparator 7. As is well known, the EFM signal has pulse durations ranging from 3 T to 11 T. At (A) in FIG. 6 is shown the waveform of the data signal V₁ that is offset in the positive direction with respect to the reference voltage V₂, such offset being particularly liable to occur to pulses of such short durations as 3 T, 4 T and 5 T. As will be noted from (B) in FIG. 6, which shows the resulting binary output from the comparator 7 in the absence of the optimization circuit 15 according to the invention, the pulse durations would be longer, and the pulse spacings shorter, than the expected correct values. The correct comparator output pulses of FIG. 6 (C) are obtainable by shifting the comparator reference voltage from V₂ to V₂ₐ, as at (A) in FIG. 6, by addition of the optimum corrective voltage from the DAC 30.

The gain control circuit 10 is in effect a known analog subtracter circuit comprising an operational amplifier 23 having a positive input 23a connected to the adder circuit 9, and a negative input 23b connected to an output 23c via a circuit 24 for production of a value to be subtracted from the adder circuit output. The circuit 24 includes two voltage-dividing resistors R₁ and R₂ connected between a d.c. supply terminal 25 and ground. The junction between the resistors R₁ and R₂ is connected to a buffer amplifier 26, the output of which is connected to the negative input 23b of the operational amplifier 23 via a resistor Rₐ. A serial connection of four other resistors R_{b}, R_{c}, R_{d} and Rₑ is connected as a feedback circuit between the output 23c and negative input 23b of the operational amplifier. Four on-off switches Q₁, Q₂, Q₃ and Q₄ are connected respectively between the resistors R_{b}-Rₑ and the output 23c of the operational amplifier 23. The gain is changed by discrete increments by the switches Q₁-Q₄. No more detailed explanation of operation is considered necessary as the gain control circuit 10 of this construction is available commercially, an example being the EFM comparator μPD 63725 by NEC.

FIG. 3 is a more detailed illustration of the optimization circuit 15 of FIG. 1. Intended to provide the optimum corrective value for the reference voltage applied to the comparator 7 with respect to each disk 1 that has been loaded in the apparatus, the optimization circuit 15 may take the form of a microcomputer or central processor unit which may be functionally or equivalently depicted as in FIG. 3.

Referring more specifically to FIG. 3, the optimization circuit 15 includes optimization command means 31 which produces a command for correction and optimization of the comparator reference voltage when either of two prescribed sets of conditions are met; that is, either when the disk tray is inserted after the apparatus has been switched on, or when the apparatus is switched on with the disk tray held inserted. The tray sensor 16 and the power-on sensor 17 are both connected to the optimization command means 31 by way of the lines 16a and 17a in order to notify the same of the necessary conditions.

In response to the optimization command from the means 31, corrective value generating means 32 puts out a series of incrementally changing corrective values for delivery both to the adder circuit 9, FIGS. 1 and 2, via a switch 37 and the DAC 30, and to tabulation means 33. The tabulation means 33 has also connected thereto the aforesaid error rate signal line 13c from the error rate corrector 13a. Reciving the error rate at each of the series of corrective values which have been added as above to the comparator reference voltage, the tabulation means 33 tabulates the relationship between the corrective values and the resulting error rates as exhibited by each particular disk 1 being played.

FIG. 4 graphically shows three different typical relationships between the series of corrective values Vₐ and the C1 error rates to be encountered in playing commercially available optical disks. The curve A₁ represents the relationship exhibited by a normal disk, such that the error rate is at a minimum when the corrective value is zero. No correction of the comparator reference voltage is needed for disks of this kind. The curves A₂ and A₃ represent the relationships characteristic of two nonstandard disks deviating from the standard disk in opposite directions. The error rate is minimized when the corrective value is at +Vₐ in the case of the curve A₂, and at −Vₐ in the case of the curve A₃.

Reading the table formed by the tabulation means 33, optimum corrective value determination means 34 chooses the optimum corrective value for the disk 1 now being played, that is, the corrective value at which the error rate of the disk is the lowest. In the cases given in FIG. 4, the optimum corrective value is either zero, +Vₐ, or −Vₐ. The optimum corrective value thus determined is sent to holding means 35, where it is held until the disk 1 is unloaded, or the disk drive turned off. Forwarded from the holding means 35 to the adder circuit 9, FIG. 1, via a switch 38 and the DAC 39, the optimum corrective value is added to the output from the LPF 8 for optimization of the reference signal V₂ₐ. Thus is the comparator 7 enabled to shape the data signal V₁, (B) in FIGS. 5 and 6, into the most error-free binary signal indicated at (B) in FIG. 5 and (C) in FIG. 6.

The optimum value holding means 35 is shown provided with reset means 36 to which are connected both the output line 16a of the tray sensor 16, FIG. 1, and the output line 17a of the power-on sensor 17. The holding means 35 is reset both when a new disk is loaded in the apparatus and when the apparatus is switched on.

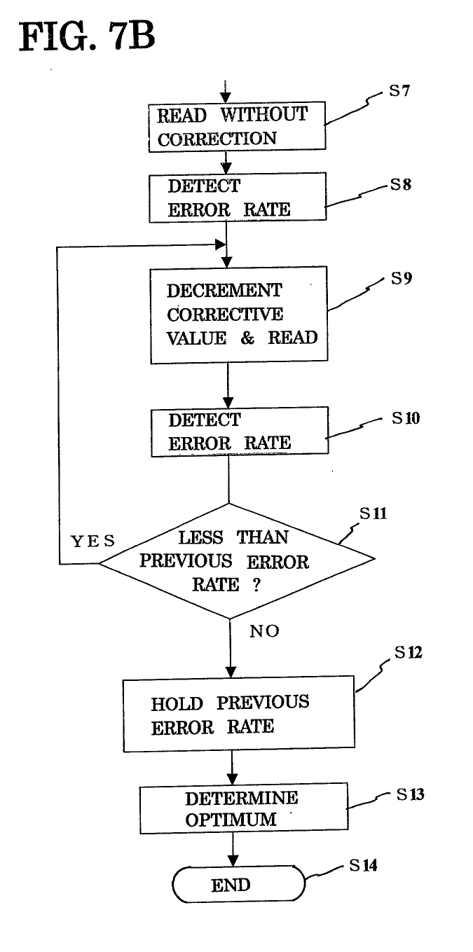

In practice the above outlined process for optimization of the comparator reference voltage may be carried out by the method of this invention which is to be factory preprogrammed as a routine or subroutine in the microcomputer or central processor unit herein shown serving as the optimization circuit 15. The computer routine is shown flowcharted on two separate drawing sheets designated FIGS. 7A and 7B. The routine may be implemented either when a reset pulse is produced by the reset means 36 of the optimization circuit 15, when the disk drive is at a standstill, awaiting a command from the computer 22, or preliminary to a retry following a read error. It is understood in the following discussion of the optimization routine that five positive corrective values and five negative corrective values are prepared, in addition to zero, and that they are first incremented in an increasing direction from zero and, after returning to zero, in a decreasing direction (i.e. decremented), in order to find the optimum value at which the error rate is most reduced.

Starting at S₀ in FIG. 7A, the routine dictates at the block S₁ to set the corrective value at zero and read a preassigned part of the disk 1. Then the CIRC C1 error rate of the recovered data is detected and written on the tabulation means 33, FIG. 3, of the optimization circuit 15 according to the next block S₂.

Then the corrective value is incremented one step in an increasing direction, and the preassigned part of the disk is read again, according to the block S₃. The error rate of the recovered data at this corrective value is again detected and stored on the tabulation means 33.

Then comes the node S₅ which asks if the error rate at the current corrective value is less than that at the previous one, which is zero in this case. If the answer is yes, it follows that the optimum corrective value may possibly, not necessarily, be greater than the current one. So the routine returns to the block S₃, and the disk is again read after incrementing the corrective value to the next higher one. The error rate at this higher corrective value is detected according to the block S₄ for comparison with that at the previous corrective value. This cycle is repeated until the answer to the node S₅ becomes no, that is, until the error rate at the current corrective value becomes not less than that at the previous one. Thereupon the error rate at the previous corrective value is held as a temporary optimum according to the block S₆.

Then the blocks S₇ and S₈ are followed to reread the disk without correction of the output from the LPF 8, FIG. 1, and to reascertain the resulting error rate.

Then, as dictated by the next block S₉, the disk is read after decrementing the corrective value by one step, and the resulting error rate is detected according to the next block S₁₀. This error rate is compared with that at the previous error rate, zero in this case, at the node S₁₁. Here again the steps S₉-S₁₁ are cyclically repeated until the error rate at the current corrective value becomes not less than that at the previous one. The answer “No” to the node S₁₁ directs the routine to the block S₁₂ where the previous corrective value is stored as another temporary optimum.

Then comes the block S₁₃ where the optimum corrective value is finally determined by comparing the two values stored as possible optimums at the block S₆ and S₁₂. The corrective value at which the error rate is lower is of course the optimum. Either of the two values will do if the error rate is the same at both. With the optimum corrective value thus finally determined, and stored on the holding means 35, FIG. 3, of the optimization circuit 15, the subroutine comes to an end at S₁₄.

The advantages gained by the present invention, specifically set forth hereinbefore with reference to the drawings, may be recapitulated as follows:

1. Any offset of the comparator reference voltage is detected from the resulting read error rate and amended for each disk by finding an optimum corrective value for the reference voltage, so that the comparator puts out approximately the same proper output, as at (B) in FIG. 5 and (C) in FIG. 6, in response to both the normal data signal, at (A) in FIG. 5, and the abnormal data signal, at (A) in FIG. 6.

2. The optimization of the comparator reference voltage is fully automatic.

3. The optimum corrective value for each disk is held until that disk is unloaded, or the disk drive turned off.

4. Any offset inherent to the comparator is eliminated at the same time.

Notwithstanding the foregoing detailed disclosure it is not desired that the present invention be limited by the exact showing of the drawings or by the description thereof. The following is a brief list of possible modifications or alterations which are all believed to fall within the scope of the invention:

1. An optimum corrective value may be ascertained for each of several sectors of each disk, thereby separately optimizing the comparator reference voltage during the reading of the associated sector of the disk. Errors will then be even more reduced for all the disk surface.

2. Instead of C1 errors, C2 errors or both C1 and C2 errors could be detected at each corrective value.

3. The optimization circuit 15 could be served by the CPU customarily used as the system controller of the disk drive.

4. An operational amplifier could be used in place of the adder circuit 9.

What is claimed is:

1. An apparatus for reading of an optical disk having data recorded along a predefined track thereon, comprising:
(a) a transducer for relatively scanning a data track on an optical disk and providing an electric output indicative of data that has been recorded thereon;
(b) a comparator having an input connected to the transducer for translating the output therefrom into a binary signal by comparing the transducer output with a reference signal;
(c) reference signal means connected between an output and another input of the comparator for providing the reference signal;
(d) a demodulator circuit connected to the comparator for translating the binary output therefrom into a data signal;
(e) error rate detector means connected to the demodulator circuit for detecting the error rate of the data signal; and
(f) corrective circuit means connected between the error rate detector means and the reference signal means for supplying to the reference signal means a signal indicative of a corrective value to be added to the reference signal according to an error rate of the data signal and hence for correcting the reference signal for decreasing the error rate of the data signal.

2. The disk-reading apparatus of claim 1 wherein the corrective circuit means comprises:
(a) corrective value generator means to be selectively connected to the reference signal means for providing a series of incremental corrective values each to be added to the reference signal;
(b) tabulation means having inputs connected to the error rate detector means and the corrective value generator means for ascertaining a relationship between the series of corrective values added to the reference signal and the resulting error rates of the data signal; and
(c) optimum value determination means connected to the tabulation means for determination of an optimum corrective value at which the error rate of the data signal is at a minimum.

3. An apparatus for most error-free reading of any of interchangeable optical disks to be loaded therein, each disk having data recorded along a predefined track thereon, comprising:
(a) a transducer for relatively scanning a data track on any of the interchangeable optical disks that has been loaded in the apparatus, and for providing an electric output indicative of data recovered from the disk;
(b) a comparator having an input connected to the transducer for translating the output therefrom into a binary signal by comparing the same with a reference signal;
(c) reference signal means connected between an output and another input of the comparator for providing the reference signal;
(d) a demodulator circuit connected to the comparator for translating the binary output therefrom into a data signal;
(e) error rate detector means connected to the demodulator circuit for detecting the error rate of the data signal;
(f) corrective value generator means for generating a series of incremental corrective values to be successively added to the reference signal for each optical disk loaded in the apparatus;
(g) tabulation means having inputs connected to the error rate detector means and the corrective value generator means for ascertaining a relationship between the series of corrective values added to the reference signal and the resulting error rates of the data signal;
(h) optimum value determination means connected to the tabulation means for determination of an optimum corrective value at which the error rate of the data signal is at a minimum; and
(i) holding means connected between the optimum value determination means and the reference signal means for holding the reference signal optimized with the optimum corrective value as long as the disk remains loaded in the apparatus.

4. The error-free disk-reading apparatus of claim 3 further comprising:
(a) a disk sensor for sensing the loading of any of the interchangeable optical disks in the apparatus;
(b) a power-on sensor for sensing the fact that the apparatus is electrically turned on; and
(c) optimization command means connected between the disk sensor and power-on sensor and the corrective value generator means for causing the latter to deliver the series of corrective values to the reference signal means either when an optical disk is loaded while the apparatus is on, or when the apparatus is turned on while an optical disk is loaded therein.

5. A method of most error-free reading of an optical disk, which method comprises:
(a) providing a comparator having an input for receiving an output from a transducer reading a disk and a demodulator circuit connected to the comparator, the comparator translating the transducer output into a binary signal by comparing the same with a reference signal supplied to another input thereof, the demodulator circuit translating the binary output from the comparator into a data signal;
(b) successively adding a series of incremental corrective values to the reference signal;
(c) detecting the error rate of the data signal at each of the corrective values added to the reference signal;
(d) ascertaining an optimum corrective value at which the error rate of the data signal is the lowest; and
(e) adding the optimum corrective value to the reference signal for most error-free reading of the disk.

6. The error-free disk-reading method of claim 5 wherein the optimum corrective value is ascertained by:
(a) detecting the error rate of the data signal after addition of each corrective value to the reference signal;
(b) comparing the error rate at each corrective value with that at the previous corrective value;
(c) adding the next corrective value to the reference signal if the error rate at the current corrective value proves less than that at the previous corrective value at step (b); and
(d) determining the previous corrective value as the optimum if the error rate at the current corrective value proves not less than that at the previous corrective value at step (b).

7. The error-free disk-reading method of claim 5 wherein the optimum corrective value is ascertained by:
(a) incrementing the corrective values in either an increasing or a decreasing direction;
(b) detecting the error rate of the data signal after addition of each corrective value to the reference signal;
(c) comparing the error rate at each corrective value with that at the previous corrective value;
(d) adding the next corrective value to the reference signal if the error rate at the current corrective value proves less than that at the previous corrective value at step (c);
(e) determining the previous corrective value as a potential optimum if the error rate at the current corrective value proves not less than that at the previous corrective value at step (c);
(f) incrementing the corrective values in the other of an increasing and a decreasing direction;
(g) detecting the error rate of the data signal after addition of each of the corrective values, being incremented according to step (f), to the reference signal;
(h) comparing the error rate at each corrective value, detected at step (g), with that at the previous corrective value;
(i) adding the next corrective value to the reference signal according to step (f) if the error rate at the current corrective value proves less than that at the previous corrective value at step (h);
(j) determining the previous corrective value as a potential optimum if the error rate at the current corrective value proves not less than that at the previous corrective value at step (h); and
(k) determining the optimum corrective value by comparing the error rates at the corrective values that were determined as potential optimums at steps (e) and (j).

8. The error-free disk-reading method of claim 5 which further comprises holding the optimum corrective value either until the reading apparatus is electrically turned off or until the disk is unloaded from the apparatus.

9. The error-free disk-reading method of claim 5 wherein the optimization of the reference signal is automatically started either when an optical disk is loaded while the apparatus is on, or when the apparatus is turned on while an optical disk is loaded therein.
